(19) United States
(12) Patent Application Publication
(10) Pub. No.: US 2009/0169444 A1
(43) Pub. Date: Jul. 2, 2009

(54) Apparatus for Producing Group III Nitride Based Compound Semiconductor

(76) Inventors: Shiro Yamazaki, Aichi (JP); Makoto Iwai, Aichi (JP); Takanao Shimodaira, Aichi (JP); Takatomo Sasaki, Osaka (JP); Yusuke Mori, Osaka (JP); Fumio Kawamura, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/225,716

(22) PCT Filed: Apr. 5, 2007
(86) PCT No.: PCT/JP2007/058024

§ 371 Date: Nov. 19, 2008

(30) Foreign Application Priority Data
Apr. 7, 2006 (JP) 2006-106861

(51) Int. Cl. B01J 19/00

(52) U.S. Cl. 422/198

(57) ABSTRACT

An object of the invention is to prevent, in the flux method, diffusion of substances that constitute the atmosphere of the outer vessel into the reactor.

The apparatus for producing a group III nitride based compound semiconductor, the apparatus including a reactor which maintains a group III metal and a metal differing from the group III metal in a molten state, a heating apparatus for heating the reactor, and an outer vessel for accommodating the reactor and the heating apparatus, characterized in that diffusion of substances that constitute the atmosphere of the outer vessel into the reactor is prevented.

### TECHNICAL FIELD

The present invention relates to a method and apparatus for producing a group III nitride based compound semiconductor. The present invention relates to the so-called flux method including feeding nitrogen to the surface of a melt such as a molten Na—Ga mixture, to thereby grow GaN on the surface of a GaN seed crystal.

### BACKGROUND ART

Methods for growing crystals of gallium nitride (GaN) and other group III nitride based compound semiconductors through the flux method are disclosed in, for example, the Patent Documents below. In one of these methods, gallium (Ga) is dissolved in molten sodium (Na) at a constant temperature of about 800° C., and gallium is reacted with nitrogen under high pressure of about 100 atm, to thereby grow gallium nitride (GaN) on the surface of a seed crystal. An exemplary apparatus 9000 for producing a group III nitride based compound semiconductor is shown in FIG. 2. The apparatus has an openable/closable double vessel structure including a reactor 100 and an outer vessel 200, which are resistant to high temperature and pressure. The reactor 100 is heated by means of heating apparatuses 31a, 31b, and 31c disposed in the outer vessel, to thereby melt sodium (Na) and gallium (Ga) contained in the reactor 100. To the reactor 100, a nitrogen feed pipe 10 and a discharge pipe 11 are connected. Feeding and discharging of nitrogen is carried out, while the internal pressure of the reactor 100 is controlled to, for example, 100 atm, by means of a controller (not illustrated).

[Patent Document 1] Japanese Patent Application Laid-Open (kokai) No. 2001-058900
[Patent Document 2] Japanese patent Application Laid-Open (kokai) No. 2003-313099

As shown in FIG. 2, the outer vessel 200 is equipped with a feed pipe 20 and a discharge pipe 21 so that the pressure difference between the vessel and the reactor 100 is reduced. Through these pipes, the reactor can be pressurized. According to the flux method, the gas fed through the feed pipe 20 is generally nitrogen, which is identical to the gas fed through the feed pipe 10. On the downstream side of the discharge pipes 11 and 21, an evacuation pump (not illustrated) is provided. Feeding and discharging of nitrogen to and from the reactor 100 is carried out by means of valves 10v and 11v provided in the feed pipe 10 and the discharge pipe 11, respectively, whereas feeding and discharging of nitrogen to and from the outer vessel 200 is carried out through control of valves 20v and 21v provided in the feed pipe 20 and the discharge pipe 21, respectively. Thus, internal pressure of the reactor 100 and that of the outer vessel 200 can be independently controlled through respective nitrogen feeding and discharging operations.

### DISCLOSURE OF THE INVENTION

Meanwhile, heating apparatuses 31a and 31c tend to discharge impurities such as dust, oxygen, moisture, and organic substances. Diffusion of the impurities such as dust, oxygen, moisture, and organic substances, present in the outer vessel 200, must be prevented so that the impurities are not taken into the reactor 100, since the diffused dust functions as a seed crystal, from which undesired crystal growth may occur. In other words, the state where the pressure of the reactor 100 is low and that of the outer vessel 200 is high is not preferred. In contrast, when the state where the pressure of the reactor 100 is high and that of the outer vessel 200 is low is continued for a long period of time, the reactor 100 inflates. This case is also problematic, since difficulty is encountered in opening the reactor 100 after completion of reaction.

Thus, an object of the present invention is to provide grow a high-quality crystal on a seed crystal, through employment of an apparatus for producing a group III nitride based compound semiconductor, the apparatus comprising a double vessel including a reactor which maintains a group III metal and a metal differing from the group III metal in a molten state, a heating apparatus for heating the reactor, and an outer vessel for accommodating the reactor and the heating apparatus, wherein diffusion of substances that constitute the atmosphere of the outer vessel into the reactor is prevented, to thereby p-event growth of useless crystals.

In a first aspect of the present invention to attain the aforementioned object, there is provided an apparatus for producing a group III nitride based compound semiconductor, the apparatus comprising a reactor which maintains a group III metal and a metal differing from the group III metal in a molten state, a heating apparatus for heating the reactor, and an outer vessel for accommodating the reactor and the heating apparatus, characterized in that diffusion of substances that constitute the atmosphere of the outer vessel into the reactor is prevented. In a second aspect of the present invention, which is directed to a specific embodiment of the first aspect, pressure of the reactor is adjusted to be higher than that of the outer vessel. In a third aspect of the present invention, which is directed to a specific embodiment of the second aspect, the difference in pressure between the reactor and the outer vessel is 5 kPa to 1 MPa.

In a fourth aspect of the present invention, which is directed to a specific embodiment of any one of the first to third aspects, the apparatus has a feed pipe for feeding a gas containing at least nitrogen from the outside of the outer vessel into the reactor, and a discharge pipe for discharging from the reactor, wherein the discharge pipe is connected to piping or feeding a nitrogen-containing gas to the outer vessel. As used herein, the term “nitrogen-containing gas” refers to a single-component gas or a gas mixture containing nitrogen molecules and/or a gaseous nitrogen compound. For example, the nitrogen-containing gas may contain an inert gas such as a rare gas in a desired proportion. In a fifth aspect of the present invention, which is directed to a specific embodiment of any one of the first to fourth aspects, the gas containing at least nitrogen is fed to the reactor at a flow rate of 1 to 200 mL/min while the pressure of the outer vessel is maintained.

In a sixth aspect of the present invention, which is directed to a specific embodiment of the fourth aspect, a group III metal or a metal differing from the group III metal is not deposited on the inner surface of the discharge pipe and that of the piping for feeding a gas containing at least nitrogen to the outer vessel. In a seventh aspect of the present invention, which is directed to a specific embodiment of the sixth aspect, the apparatus has a tool for adsorbing for removing or trapping a group III metal or a metal differing from the group III metal, between the discharge pipe and the piping for feeding a gas containing at least nitrogen to the outer vessel. In an eighth aspect of the present invention, which is directed to a specific embodiment of the sixth or seventh aspect, the discharge pipe and the piping for feeding a gas containing at least nitrogen to the outer vessel is maintained at a temperature higher than that of a vapor of a group III metal or a metal differing from the group III metal.

In a ninth aspect of the present invention, which is directed to a specific embodiment of any one of the first to eighth aspects, the group III metal is gallium (Ga) and the metal differing from the group III metal is sodium (Na).

According to the present invention, the internal pressure of the reactor can be maintained slightly higher than that of the outer vessel. Therefore, impurities such as dust, oxygen, moisture, and organic substances present in the outer vessel are not taken into the reactor. In addition, since the difference in pressure is relatively small, no difficulty is encountered in opening the reactor, which would otherwise be caused by inflation. Feeding and discharging of nitrogen to and from the inside of the reactor and the outside of the reactor (i.e., the inside of the outer vessel) can be performed simultaneously, ensuring high-speed introduction of gas. Thus, the time required for the steps can be shortened, and impurities such as dust, oxygen, moisture, and organic substances are not taken into the reactor, whereby a group III nitride based compound semiconductor single crystal of high crystallinity can be produced. Meanwhile, nitrogen discharged from the reactor contains metal vapor. Therefore, in the case where the nitrogen discharged by the reactor is returned to the outside of the reactor (i.e., the inside of the outer vessel), in a preferred mode, an apparatus for removing the metal vapor present in the reactor is installed, and nitrogen from which the metal vapor has been removed by means of the apparatus is returned to the inside of the outer vessel.

### BRIEF DESCRIPTION OF THE DRAWINGS

FIG. 1 is a schematic view of the configuration of an apparatus 1000 for producing a group III nitride based compound semiconductor of Embodiment 1 of the present invention.

FIG. 2 is a schematic view of the configuration of a conventional apparatus 9000 for producing a group III nitride based compound semiconductor.

### BEST MODES FOR CARRYING OUT THE INVENTION

The present invention is applicable to an apparatus for producing a group III nitride based compound semiconductor through the flux method, the apparatus employing a reactor, a heating apparatus, and an outer vessel for accommodating the heating apparatus.

### Embodiment 1

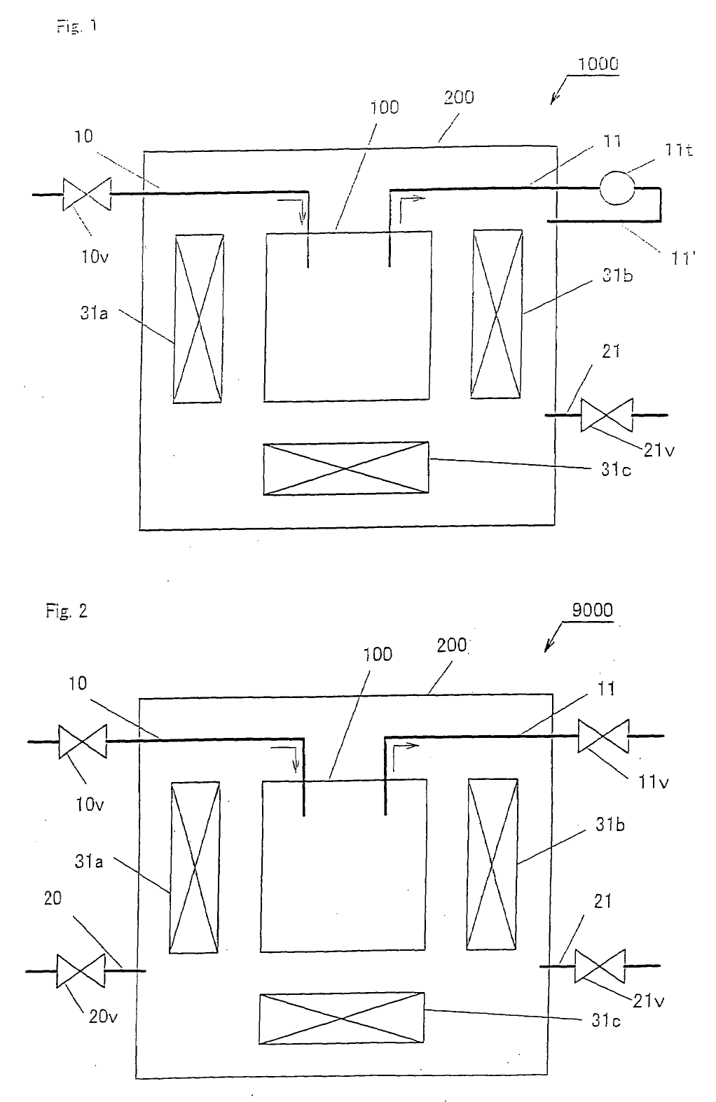

FIG. 1 is a schematic view of the configuration of an apparatus 1000 for producing a group III nitride based compound semiconductor of Embodiment 1 of the present invention. As shown in FIG. 1, the production apparatus 1000 has an openable/closable double vessel structure including a reactor 100 and an outer vessel 200, which are resistant to high temperature and pressure. The reactor 100 has a capacitor of about 0.1 to 100 L, and the outer vessel 200 has a capacity of about 1 to 100 m³. In the outer vessel 200, heating apparatuses 31a, 31b, and 31c are disposed. The heating apparatuses 31a and 31b are disposed near the sidewall of the reactor 100, and the heating apparatus 31c is disposed under the bottom surface of the reactor 100. By means of these heating apparatuses 31a, 31b, and 31c, the reactor 100 is heated to, for example, 800 to 900° C. To the upper section of the reactor 100, a nitrogen feed pipe 10 and a discharge pipe 11 are connected. The nitrogen Feed pipe 10 is introduced into the upper section of the outer vessel 200, and the discharge pipe 11 is introduced into the upper section of the outer vessel 200 and extends to the outside of the outer vessel 200. A valve 10v is provided in the nitrogen feed pipe 10, whose one end is connected to a high-pressure nitrogen tank (not illustrated). Nitrogen is fed from the nitrogen tank to the reactor 100. The nitrogen feed pipe 10 and the discharge pipe 11 are heated to a temperature almost equivalent to the reactor temperature and maintained at 800 to 900° C. In the feed and discharge pipes, sodium vapor and gallium vapor are not condensed or solidified.

A trap 11t is connected to the discharge pipe 11 in the outside of the outer vessel 200. When the trap 11t is cooled through an arbitrary method, sodium vapor and gallium vapor are condensed, whereby metallic elements are removed from the discharge gas. In addition, a secondary feed pipe 11′ is connected to the trap 11t. Through the secondary feed pipe, the gas from which sodium vapor and gallium vapor have been removed; i.e., nitrogen gas, is fed to the inside of the outer vessel 200 and the outside of the reactor 100. To the lower section of the outer vessel 200, a discharge pipe 21 is connected. The other end of the discharge pipe 21 is connected to an evacuation pump (not illustrated) via a valve 21v. The feed of nitrogen supplied from the nitrogen tank and the discharge of the evacuation pump are controlled by means of a controller (not illustrated) such that the internal pressure of the reactor 100 is adjusted to, for example, 100 atm.

Needless to say, the trap 11t may be provided outside the outer vessel 200 as shown in FIG. 1 or inside the outer vessel.

During evacuation and purging with nitrogen of the reactor 100 and the outer vessel 200 before the start of reaction, a pressure gradient is created all the time, in order from highest to lowest, across the feed pipe 10, the reactor 100, the discharge pipe 11, the secondary feed pipe 11′, the outer vessel 200, and the discharge pipe 21. That is, when the valve 10v is closed and the valve 21v is open for the evacuation by means of the evacuation pump, or when the valve 21v is closed and the valve 10v is open for introducing nitrogen from the nitrogen tank, pressure gradient is created such that the pressure is always the highest in the feed pipe 10, and the pressure decreases in order of the reactor 100, the discharge pipe 11, the secondary feed pipe 11′, the outer vessel 200, and the discharge pipe 21. In this case, the difference in pressure between the inside of the reactor 100 and the outside of the reactor (i.e., The inside of the outer vessel 200) is readily adjusted to smaller than 1 atm. Thus, impurities present in the outer vessel 200 such as dust, oxygen, moisture, and organic substances are not taken in the reactor 100, and the reactor 100 does not considerably inflate, which would otherwise be caused by the pressure difference between the inside and the outside of the reactor. Therefore, quality of the formed crystal can be enhanced, and the lid of the reactor 100 can be readily removed after completion of crystal growth.

During reaction, the feed of nitrogen is controlled by means of the valve 10v, and the discharge of nitrogen is controlled by means of the valve 21v, such that the internal pressure of the outer vessel 200 is maintained at 1 MPa to 100 MPa for a predetermined period of time. During maintenance of the pressure, nitrogen is fed into the reactor 100 so as to maintain positive pressure with respect to the outside of the reactor. The flow rate of nitrogen is preferably 1 to 200 mL/min. When the flow rate is excessively small, positive pressure fails to be maintained, whereas when the flow rate is excessively high, the internal temperature of the reactor 100 varies. More preferably, the flow rate is 50 to 100 mL/min.

In addition to the configuration shown in FIG. 1, an additional valve and an evacuation pump may be connected to the trap 11t on the outlet side. Alternatively, an additional feed pipe and valve connected to the nitrogen tank may be added to the outer vessel 200. Similar to the employment of the apparatus 9000 shown in FIG. 2 for producing a group III nitride based compound semiconductor, nitrogen in the outer vessel 200 may be replaced after completion of reaction and before replacement of nitrogen in the reactor 100, so as to cool the reactor 100.

1. An apparatus for producing a group III nitride based compound semiconductor, the apparatus comprising
a reactor which maintains a group III metal and a metal differing from the group III metal in a molten state,
a heating apparatus for heating the reactor, and
an outer vessel for accommodating the reactor and the heating apparatus,
wherein diffusion of substances that constitute the atmosphere of the outer vessel into the reactor is prevented.

2. An apparatus for producing a group III nitride based compound semiconductor as described in claim 1, wherein pressure of the reactor is adjusted to be higher than that of the outer vessel.

3. An apparatus for producing a group III nitride based compound semiconductor as described in claim 2, wherein the difference in pressure between the reactor and the outer vessel is 5 kPa to 1 MPa.

4. An apparatus for producing a group III nitride based compound semiconductor as described in claim 1, further comprising a feed pipe for feeding a gas containing at least nitrogen from the outside of the outer vessel into the reactor, and a discharge pipe for discharging from the reactor, wherein the discharge pipe is connected to piping for feeding a nitrogen-containing gas to the outer vessel.

5. An apparatus for producing a group III nitride based compound semiconductor as described in claim 1, wherein the gas containing at least nitrogen is fed to the reactor at a flow rate of 1 to 200 mL/min while the pressure of the outer vessel is maintained.

6. An apparatus for producing a group III nitride based compound semiconductor as described in claim 4, wherein a group III metal or a metal differing from the group III metal is not deposited on the inner surface of the discharge pipe and that of the piping for feeding a gas containing at least nitrogen to the outer vessel.

7. An apparatus for producing a group III nitride based compound semiconductor as described in claim 6, further comprising a tool for adsorbing for removing or trapping a group III metal or a metal differing from the group III metal, between the discharge pipe and the piping for feeding a gas containing at least nitrogen to the outer vessel.

8. An apparatus for producing a group III nitride based compound semiconductor as described in claim 6, wherein the discharge pipe and the piping for feeding a gas containing at least nitrogen to the outer vessel are maintained at a temperature higher than that of a vapor of a group III metal or a metal differing from the group III metal.

9. An apparatus for producing a group III nitride based compound semiconductor as described in claim 1, wherein the group III metal is gallium (Ga) and the metal differing from the group III metal is sodium (Na).

10. An apparatus for producing a group III nitride based compound semiconductor as described in claim 2, further comprising a feed pipe for feeding a gas containing at least nitrogen from the outside of the outer vessel into the reactor, and a discharge pipe for discharging from the reactor, wherein the discharge pipe is connected to piping for feeding a nitrogen-containing gas to the outer vessel.

11. An apparatus for producing a group III nitride based compound semiconductor as described in claim 3, further comprising a feed pipe for feeding a gas containing at least nitrogen from the outside of the outer vessel into the reactor, and a discharge pipe for discharging from the reactor, wherein the discharge pipe is connected to piping for feeding a nitrogen-containing gas to the outer vessel.

12. An apparatus for producing a group III nitride based compound semiconductor as described in claim 2, wherein the gas containing at least nitrogen is fed to the reactor at a flow rate of 1 to 200 mL/min while the pressure of the outer vessel is maintained.

13. An apparatus for producing a group III nitride based compound semiconductor as described in claim 3, wherein the gas containing at least nitrogen is fed to the reactor at a flow rate of 1 to 200 mL/min while the pressure of the outer vessel is maintained.

14. An apparatus for producing a group III nitride based compound semiconductor as described in claim 4, wherein the gas containing at least nitrogen is fed to the reactor at a flow rate of 1 to 200 mL/min while the pressure of the outer vessel is maintained.

15. An apparatus for producing a group III nitride based compound semiconductor as described in claim 7, wherein the discharge pipe and the piping for feeding a gas containing at least nitrogen to the outer vessel are maintained at a temperature higher than that of a vapor of a group III metal or a metal differing from the group III metal.

16. An apparatus for producing a group III nitride based compound semiconductor as described in claim 2, wherein the group III metal is gallium (Ga) and the metal differing from the group III metal is sodium (Na).

17. An apparatus for producing a group III nitride based compound semiconductor as described in claim 3, wherein the group III metal is gallium (Ga) and the metal differing from the group III metal is sodium (Na).

18. An apparatus for producing a group III nitride based compound semiconductor as described in claim 4, wherein the group III metal is gallium (Ga) and the metal differing from the group III metal is sodium (Na).

19. An apparatus for producing a group III nitride based compound semiconductor as described in claim 5, wherein the group III metal is gallium (Ga) and the metal differing from the group III metal is sodium (Na).

20. An apparatus for producing a group III nitride based compound semiconductor as described in claim 6, wherein the group III metal is gallium (Ga) and the metal differing from the group III metal is sodium (Na).
